(19) United States
(12) Patent Application Publication
(10) Pub. No.: US 2006/0293925 A1
(43) Pub. Date: Dec. 28, 2006

(54) System for storing medical records accessed using patient biometrics

(76) Inventor: Leonard Flom, Fairfield, CT (US)

Correspondence Address: ST. ONGE STEWARD JOHNSTON & REENS, LLC, 986 BEDFORD STREET, STAMFORD, CT, 06905-5619, US

(21) Appl. No.: 11/471,342

(22) Filed: Jun. 20, 2006

Related U.S. Application Data
(60) Provisional application No. 60/692,940, filed on Jun. 22, 2005.

(51) Int. Cl. G06F 19/00; G06F 17/30; G06Q 99/00

(52) U.S. Cl. 705/3; 707/9; 705/50

(57) ABSTRACT

A system for viewing and updating medical records using patient biometrics including at least one biometrics database including a plurality of biometric identifiers, at least one records database including a plurality of medical data records, at least one biometrics reader for receiving two or more biometric identifiers from a patient, a central records processor, software executing on the processor for querying the at least one biometrics database to verify the two or more biometric identifiers, and software executing on the processor for retrieving a medical data record corresponding to the two or more biometric identifiers from the at least one records database.

### CROSS-REFERENCE TO RELATED APPLICATIONS

This application claims priority benefits under 35 § U.S.C. 119(e) of the U.S. Provisional Application No. 60/692,940, filed on Jun. 22, 2005.

### FIELD OF THE INVENTION

The present invention relates generally to electronic healthcare record storage and retrieval and, more specifically, to a system and method in which security of the patients' records is strictly maintained.

### BACKGROUND OF THE INVENTION

Many medical records are today created electronically because, at least in part, electronic records are simpler and less expensive to create, maintain and work with as compared to traditional paper records. In fact, traditional paper records are being converted to electronic formats at an accelerated pace. In response to this electronic revolution, systems have been developed which attempt to protect the privacy of medical information while utilizing the advantages of electronic information technology.

Some of the first systems developed involved the use of personal identification cards. These cards would be electronically coded to provide an individual with secure access to certain types of information and many such cards have received patents. For example, U.S. Pat. No. 6,131,090 relates to a method and system for providing controlled access to information stored on a smartcard. The system includes a data processing center maintained by a trusted third party for storing a database of authorizations of various service providers to access information pertaining to individuals, and for responding to requests by service providers for access from terminals which communicate with the data processing center and smartcards storing the individuals' information. The information is stored on the smartcard in encrypted form and the data processing center provides an access code, which includes a key for decrypting the information, only to service providers who are authorized to access the information. The service provider then sends the access code to the smartcard, which verifies the access code and decrypts and outputs the requested information. The smartcard then computes a new key as a function of information unique to each access session and uses the new key to re-encrypt the information, and then erases the new key. The data processing center also computes the new key so that the data processing center can provide an access code including the new key for the next request for access.

U.S. Pat. No. 5,325,294 relates to a medical privacy system for providing authorized access to medical information concerning an individual. According to this system, a computer database receives and stores an individual's medical information, but does not contain a name, address or any other similar information by which that individual can be identified. The individual is given an identification card containing a photograph or holographic image of the individual and a confidential first identification number that is unique to the individual, where both the image and the first identification number are visually perceptible and cannot be altered without detection. The individual is also given a second identification number that is not contained on the card and is unique to the individual. The database can be accessed telephonically and the individual's medical information accessed after the first and second identification numbers are provided. A cryptographic module such as a smartcard is disclosed in U.S. Pat. No. 5,721,777. A computerized system that can be accessed by smartcard is disclosed in U.S. Pat. No. 5,832,488.

U.S. Pat. No. 5,465,082 relates to a distributed data processing network containing multiple memory card databases at terminal nodes of the network. The network is programmed to automatically perform routine communications operations such as conveying identification information between terminal nodes and interior nodes. This system is typically found in a single institution and generally communicates poorly if at all with other systems. U.S. Pat. No. 5,867,821 relates to a method and apparatus for distribution and administration of medical records.

U.S. Pat. No. 5,899,998 relates to a method and system for maintaining and updating computerized records in a self-updating system that employs point-of-service stations disposed at medical service locations. Each patient carries a portable data carrier such as a smart card that contains the patient's complete medical history. Interaction between the portable data carriers and the point of service stations affects a virtual communication link that ties the distributed databases together without the need for online or live data connections. The point-of-service stations are also interconnected over a communications network through a switching station that likewise does not rely on online, live communications.

Other medical information systems, not based on smartcards, have also received patents. For example, U.S. Pat. No. 5,915,240 relates to a medical lookup reference computer system for accessing medical information over a network. The system partitions the functioning of the system between a client and a server program in an optimal manner to assure synchronization of the master medical information database on the servers with the local medical information databases on the client, minimize the use of network resources, and allow new types of medical information to be easily included in the system. A server on the network maintains a description of its medical information, as well as the most up to date medical reference information. The client program maintains a local database which is automatically synchronized over the network with revisions and new medical information, and provides a user with an interface to fully review the information in the database.

U.S. Pat. No. 5,924,074 relates to a medical records system that creates and maintains all patient data electronically. The system captures patient data, such as patient complaints, lab orders, medications, diagnoses and procedures, at its source at the time of entry using a graphical interface having touch screens. The system permits instant, sophisticated analysis of patient data to identify relationships among data considered.

U.S. Pat. No. 5,930,759 relates to a system or network for assembling, filing and processing healthcare data transactions and insurance claims made by patients pursuant to healthcare policies issued to the patients by insurance companies or other carriers for services provided to the patients at healthcare facilities.

U.S. Pat. No. 5,946,659 relates to a multiple user computerized clinical care system which includes the use of a group of terminals communicating with a central computer system for sending and receiving patient information for storage and retrieval purposes. The system and method include managing patient information variance requests by storing the variance information in the order in which the variance requests are received. The terminals are then supplied with the stored variance information to enable the terminals of the computer system to receive current updated patient information for a given patient substantially concurrently as the updated information is being entered at a plurality of the terminals, without causing any user to wait for the current variance information.

U.S. Pat. No. 5,974,389 relates to a patient medical record system that includes a number of caregiver computers, and a patient record database with patient data coupled to the caregiver computers selectively providing access to the patient data from one of the caregiver computers responsive to a predetermined set of access rules. The predetermined set of rules includes a rule that access to a predetermined portion of the patient data by a first caregiver must be terminated before access to the same predetermined portion of the second caregiver is allowed.

U.S. Pat. No. 6,032,119 relates to a personalized display of health information. Delivery of information to a patient suffering from a chronic condition is personalized by displaying the health information directly on a customized image of a body. The patient's medical records, standards of care for the condition, prescribed treatments, and patient input are applied to a generalized health model of a disease to generate a personalized health model of the patient.

U.S. Pat. No. 6,073,106 relates to a method of managing and controlling access to personal information. According to this patent, via internet communication or via phone, facsimile, or mail, a participant is prompted to provide a constant identifier and a selected password. Emergency and confidential categories of medical information are identified, and the participant is prompted to provide personal information in each of the categories and a different personal identification number for each category. The person is also instructed to provide an instruction to disclose or to not disclose the personal information in the emergency category in the event a requester of the information is an emergency medical facility and is unable to provide the participant's identification number. Alteration of any of the participant's medical information is enabled upon presentation of the participant's identifier and password by the requester. The emergency information or the confidential information is disclosed upon presentation of the participant's identifier and identification number.

In response to the growth of the Internet, a few companies have arisen which claim to provide healthcare professionals with medical information over the Internet. For example, WebMD Corporation provides a service called MyHealthRecord, which it alleges enables users to organize health information online from any location via the Internet. Medscape asserts that it provides healthcare professionals and consumers with healthcare information through a service called AboutMyHealth. With this service, personal and family health information may be stored and persons can view portions of their health records. PersonalMD.com features online medical records management and an e-file, which it alleges enables users to streamline their health and medical records by maintaining them in one secure and confidential file that can be accessed via the Internet. Another, Medicalrecords.com, asserts that it enables users to store and manage medical records and provides personalized health news. HealthHero Network develops and markets a technology platform for remote patient monitoring care management and specialized research. The “Health Buddy,” which is associated with this service, is a device used by patients to respond to inquiries concerning symptoms and treatment.

Although all of these companies take advantage of the capabilities of the Internet, none provide the security necessary to compile and maintain primary records. In response to a perceived lack of guidance about the security of individual medical records, the U.S. Congress enacted the Health Insurance Portability and Accountability Act of 1996 (“HIPAA”). A principal purpose of HIPAA is to ensure that an individual's privacy in their own medical records is adequately maintained. HIPAA is also designed to protect the security of those records, as well as govern the way in which electronic medical information (including related payment information) is exchanged. HIPAA's privacy, security and transactions standards require that the fundamental business practices for hospitals, doctors, health plans, health clearinghouses and health insurers, and those that deal with them, be changed and pose new challenges to the entire healthcare industry. When final privacy regulations were promulgated by the Department of Health and Human Services in December of 2000, they created broad standards for the protection of both electronic and non-electronic medical records.

Exactly how protection under HIPAA is to be assured or even how HIPAA is to be implemented has not previously been determined. No system exists which complies with all aspects of HIPAA and none has comprehensively addressed HIPAA's requirements. Thus, a need exists for a safe, economically efficient and secure system that complies with HIPAA and its subsequent versions and replacements, and that protects the exchange of medical information so as to advance the underlying policy goals of HIPAA, the continued improvement of personal and public healthcare.

The use of a biometric specimen to identify the location of data has been discussed in a recent U.S. patent application. U.S. Patent Application Publication U.S. 2006/002643 relates to a database of pointers may be used to identify the location of medical information wherein a single biometric specimen may be required to obtain those pointers. However, the disclosed system provides only for determining the location of information stored and maintained in different locations. Further, the publication discusses no means for securely storing and updating the information after it is located.

### SUMMARY OF THE INVENTION

According, it is an object of the present invention to provide a system and method for securely storing, viewing and updating electronic medical records.

It is a further object of the present invention to provide a system and method for securely storing, viewing and updating electronic medical records using patient biometrics, such as multiple biometric identifiers.

It is a further object of the present invention to provide system and method for storing, viewing and updating electronic medical records in which complete anonymity of the patient to which each record pertains is maintained.

It is a further object of the present invention to provide a system and method for storing, viewing, and updating medical records wherein a first patient authorization is required to view a medical record and a second and different patient authorization is required to modify the medical record.

These and other objectives are achieved by providing a system for viewing and updating medical records using patient biometrics including at least one biometrics database including a plurality of biometric identifiers, at least one records database including a plurality of medical data records, at least one biometrics reader for receiving two or more biometric identifiers from a patient, a central records processor, software executing on the processor for querying the at least one biometrics database to verify the two or more biometric identifiers, and software executing on the processor for retrieving a medical data record corresponding to the two or more biometric identifiers from the at least one records database.

Further provided is a system for viewing and updating medical records using patient biometrics including at least one biometrics database including a plurality of biometrics identifiers, at least one records database including a plurality of medical data records, at least one biometrics reader for receiving at least one biometric identifier from a patient, a central records processor, software executing on the processor for querying the at least one biometrics database to verify the at least one biometric identifier, software executing on the processor for retrieving a medical data record corresponding to the at least one biometric identifier from the at least one records database, software executing on the processor for receiving a pass code, and software executing on the processor for receiving update data and storing the update data in the records database upon verification of the pass code.

Further provided is a method of generating an electronic medical data record accessible using patient biometrics, including the steps of receiving a new record request from a user, receiving a plurality of biometric identifiers from the user, storing the plurality of biometric identifiers in a biometrics database, associating a pass code with the plurality of biometric identifiers, receiving medical data, and storing the medical data in a location of a record database corresponding to at least one of the pass code and the plurality of biometric identifiers.

Further provided is a method of accessing an electronic medical record using patient biometrics, including the steps of receiving at least one biometric identifier pertaining to a patient from a healthcare computer, querying a biometrics database to determine a medical data record associated with the at least one biometric identifier, querying a medical records database to retrieve the medical data record, and sending the medical data record to the healthcare computer for viewing.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a schematic diagram of a system for storing, viewing and updating medical records according to the present invention.

FIG. 2 is another schematic diagram of the system for storing, viewing and updating medical records shown in FIG. 1.

FIG. 3 is a method of generating an electronic medical record employable by the system shown in FIGS. 1 and 2.

FIG. 4 is a method of storing, viewing and updating electronic medical records employable by the system shown in FIGS. 1 and 2.

### DETAILED DESCRIPTION OF THE INVENTION

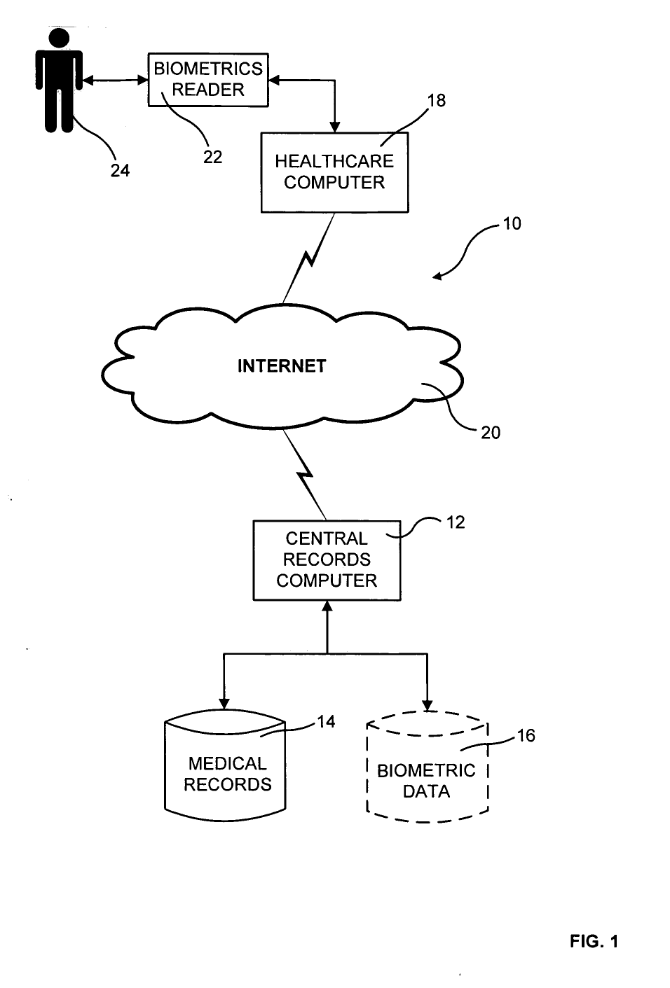

FIG. 1 shows a system 10 for storing and retrieving sensitive records, such as medical records, in accordance with the present invention. The system 10 includes at least one central records computer 12 in communication with a medical records repository or database 14. The medical records database 14 has stored thereon sets of medical records for a plurality of users or patients.

The medical records may include any of numerous types of medical information typically found in such records, such as information related to allergies, medications taken, medical conditions, past medical treatments and/or diseases, family history, results of previous diagnostic procedures, etc. The medical records may further include birth records and/or an electronic birth certificate. The medical records may further include health insurance information pertaining to the particular patient. In some embodiments, the records include other sensitive information including, but not limited to, financial information and citizenship or passport information.

The medical records in the medical records repository or database 14 need not include personal information of the patient (e.g., the patient's name). Instead, the medical records stored on medical records database 14 may be identified using one or more biometric identifiers associated with the patient. There are many types of known biometric identifiers, any of which may be employed, including fingerprints, iris or retinal patterns, DNA sequences, etc. In some embodiments, the patient's facial features or structure is used as one of the biometric identifiers. In some further embodiments, the biometric identifiers include the patient's skeletal structure or topography, e.g., captured via imaging radar.

Rather than the biometric identifier(s) being stored as part of the medical records stored on medical records database 14, the biometric identifier(s) associated with each patient may be stored on a separate biometrics database 16. When such is the case, it may be preferable for the biometrics data for each patient stored on biometrics database 16 to have associated therewith a patient identification number, such as an alphanumeric pass code or the like, which may also be associated with one of the medical records stored on medical records database 14. In this fashion, medical records may be cross-referenced with biometrics data for each patient without using the patient's name or other personal information (e.g., name, social security number, etc).

System 10 also includes at least one, but preferably many, healthcare computers 18, which are generally located at some type of healthcare facility, such as a doctor's office, a hospital, an emergency center, a clinic, a healthcare center, etc. Healthcare computers 18 are in communication with central records computer 12 via a network 20, such as the Internet. Each healthcare computer 18 has associated therewith a biometrics reader 22 which is adapted read biometric data (e.g., biometrics data 30) from a patient 24. The biometrics reader 22 may, for example, include a fingerprint reader, an iris scanner and/or a DNA or genetic analyzer. The biometrics data received from the patient 24 can then be sent from the healthcare computer 18, via network 20, to the central records computer 12. The central records computer 12 and/or medical records repository may be fully automated or human assisted. For example, the central records computer 12 may receive physical specimens for analysis by a person. The central records computer 12 may also receive digital biometric data generated from specimens at a healthcare facility and/or computer 18. Central records computer 12 then uses the received biometrics data to query medical records database 14 and/or biometrics database 16 in order to retrieve any patient medical records associated with biometrics data that matches the biometrics data supplied by healthcare computer 18.

At the same time, the authority of the person requesting the medical records is verified in that the fact that the requesting party possesses the biometrics of the patient whose records are located is sufficient to evidence authorization of the patient. Preferably the system 10 requires multiple biometrics or biometric identifiers for verification. For example, the system 10 may require two biometric identifiers for verification, or three or more biometric identifiers for verification (e.g., fingerprint data, iris scan data, and DNA data). Upon verification, the central records computer 12 transmits any located medical records to the requesting healthcare computer 18 via network 20.

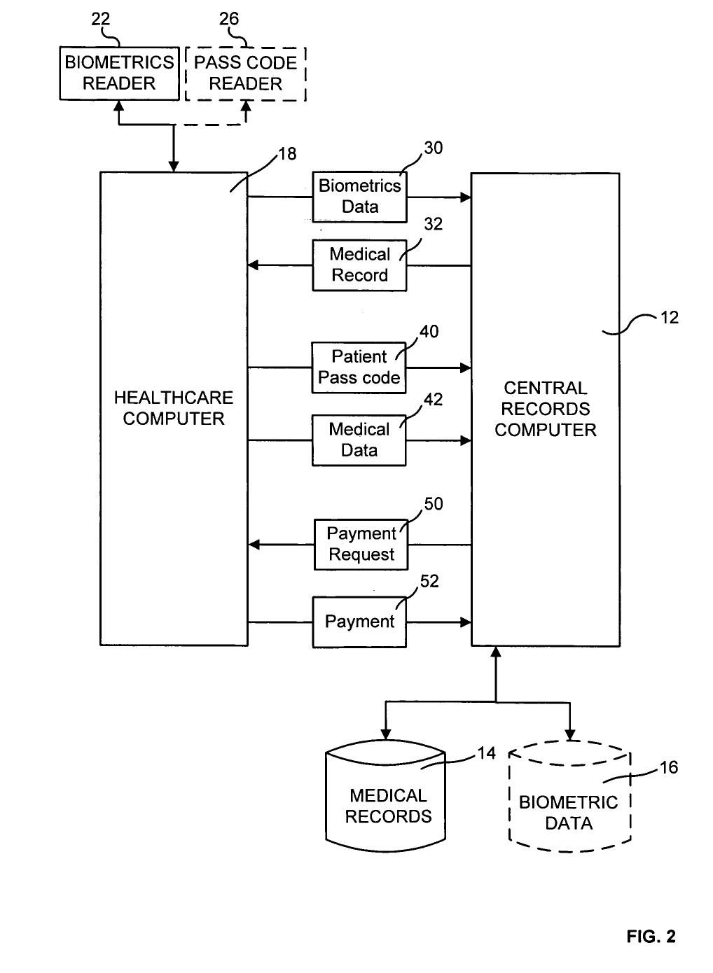

FIG. 2. shows another view of the system 10. As shown, the healthcare computer 18 sends biometrics data 30 and/or biometrics identifiers to the central records computer 12. In some embodiments, the biometric data 30 is encrypted and/or encoded. Upon verification of the biometrics data 30, the centralized records computer 12 locates and sends a medical record 32 (e.g., or electronic copy thereof) corresponding to the biometrics data 30 to the requesting healthcare computer 18. The medical record 32 may also be encrypted and/or encoded. Generally the healthcare computer 18 or user thereof (e.g., healthcare practitioner) is authorized only to view the medical record 32 upon the initial verification of the biometrics data 30. For example, the requesting healthcare provider generally may only view an electronic version or copy of the medical record 32 and/or print a hard copy thereof.

However, when a medical record 32 is viewed for treatment purposes, it is likely that the healthcare practitioner will generate new medical data 42 regarding the patient 24. The patient 24 may then choose to permit the healthcare practitioner to update his/her medical record 32 accordingly. However, additional authorization is necessary to update or modify the medical record 32 in the medical record database 14. For example, to update the medical record 32, the patient 24 may provide or securely enter a pass code 40 such as a unique alphanumeric pass code.

The pass code 40 may be entered or provided to the system 10 by any means. For example, the pass code 40 may be entered by the patient 24 via pass code reader 26 such as a keyboard or a secure keypad (e.g., data encrypting keypad) and sent electronically to the central records computer 12 for verification. The pass code 40 may further be spoken and received via a voice recognition application of the pass code reader 26. In some embodiments, the medical record 32 further includes voice data for the patient 24 and therefore the system 10 only verifies the pass code 40 when spoken by the patient 24.

In some embodiments, medical data 42 may be added to or stored in a medical record 32 using the pass code 40 alone. In some other more preferable embodiments, medical data 42 may only be added to or stored in a medical record 32 upon provision and verification of the patient's biometrics data 30 (e.g., multiple biometric identifiers) and the pass code 40. Therefore, while a healthcare practitioner may readily view the medical record 32 upon presentation of the patient's biometric identifiers or data 30, the medical record 32 may only be modified or updated upon provision of the biometric data 30 with the pass code 40. As such, the patient has complete control over the content of his/her medical record 32.

In addition to authorizing others to update his/her medical record 32, a patient 24 may also access and/or update his/her own medical record 32 using his/her biometrics data 32 and pass code 40. For example, a patient 24 may provide biometrics data 30 and/or pass code 32 via a healthcare computer 18. For example, the healthcare computer 18 may be a personal computer or computer kiosk optionally having a biometrics reader 22. The patient 24 may then submit medical data 42 (e.g., electronically) directly to the central records computer 12 for storage in his/her medical record 32.

It is contemplated that patients may pay a maintenance or subscription fee for use of the system 10 of the present invention. For patients who choose to store personal data or other identifying information with their medical record 32, the patients may simply be billed periodically for their subscription fee (e.g., by mail or email). However, the system 10 according to the present invention allows users or patients to maintain a completely anonymous medical record 32. Therefore, a patient may keep track of when payments are due and submit an anonymous payment by mail or via a healthcare computer 18. For example, the patient may provide cash to a healthcare practitioner who then submits an electronic payment 52 using the patient's pass code 40.

The system 10 may also send payment requests 50 and/or reminders to a healthcare computer 18. For example, they central records computer 12 may transmit a payment reminder or request 50 to a healthcare computer 18 that accesses the patient's medical record 32 at or around the time when subscription fees are coming due. The healthcare practitioner may then collect a payment from the patient by any means (e.g., cash, check, credit card) and provide a payment 52 on the patient's behalf without the necessity of revealing the patient's identity. Some patients may also choose to permit his/her primary care physician to receive correspondence on his/her behalf. Therefore, the primary care physician may receive a payment request 50 pertaining to one or more of his/her anonymous patients and notify the patients and/or provide payment 52 accordingly.

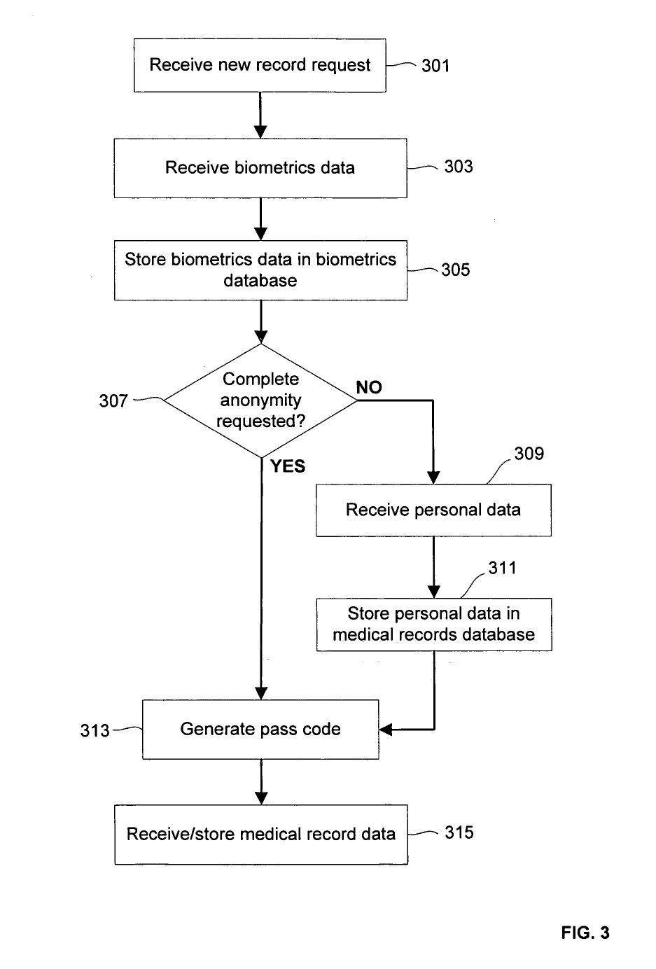

FIG. 3 shows a method of generating a medical record employable by the system 10. First, a new record request is received, e.g., from a healthcare computer 18 (step 301). The new record request may be for a patient 24 or user of any age. For example, the new record request may be for a child shortly after birth (requested by an authorized physician or guardian). Biometrics data is then collected from the new patient (e.g., via a biometrics reader 22) and sent to the central records computer (step 303). The biometrics data may include any number of biometrics identifiers including, but not limited to, fingerprints, iris or retinal patterns, DNA sequences, facial features and/or recognition, and skeletal structure and/or topography. The biometrics data may be generated from specimens at a health care facility. Alternatively, a user may submit physical specimens to a company or organization managing the records repository for analysis at the company's location. The biometrics data is stored in a biometrics database (step 305).

The patient may then choose whether or not to provide some personal data (e.g., name, address, social security number, emergency contact, insurance information, etc). If so, the personal data is received by the central records computer and stored in the medical records database (steps 307-311). The central records computer further receives or generates a pass code 40 (e.g., unique alphanumeric pass code) for the patient 24 (step 313). Finally, medical records data is collected and stored in a location corresponding to the pass code and/or biometric data (step 315). The medical records data may be provided by the patient (e.g., electronically, by mail and/or fax, etc). Alternatively, the medical records data may be provided, with the patient's permission (or guardian's permission), by the patient's healthcare practitioner(s). For example, in the case of a new born, the hospital may supply medical data 42 related to the child's birth and initial care as well as information necessary to create an electronic birth certificate in the medical record database 14 (e.g., date, time, weight, parents, etc).

Upon creation of a new medical record, a patient 24 may request to remain completely anonymous (step 307). If complete anonymity is requested, the system 10 only generates the unique pass code (e.g., alphanumeric pass code) and no personal data is stored in the medical record. The system 10 therefore may only identify medical data record by its corresponding biometrics identifiers and pass code. The method may further include a step of collecting a payment, e.g., electronically or by mail.

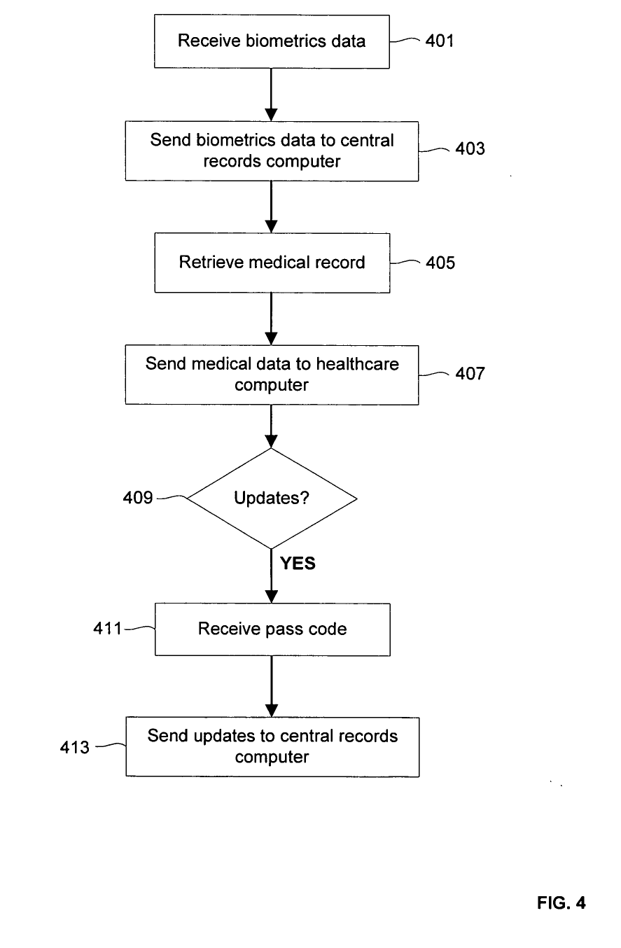

FIG. 4 shows a method of storing and retrieving medical records employable by the system 10. First, biometrics data is received (step 401). For example, a patient being admitted to a hospital may provide a finger print, iris scan, and DNA sample (e.g., via a biometrics reader 22). The biometrics data is sent (e.g., electronically) to a central records computer 12 for verification (step 403). If the biometrics data is verified and a corresponding medical record located, the medical record (e.g., electronic copy) is sent to the requesting healthcare computer 18 (steps 405-407).

During or upon completion of any treatment, the healthcare facility and/or practitioner may have new or updated medical data to provide (step 409). If the patient desires for his/her electronic medical record to be updated accordingly, the patient may provide his/her pass code (e.g., via a secure keypad or other pass code reader) to authorize the storage of data to his/her medical record (step 411). The updates are then sent to the central records computer and stored in the medical records database upon verification of the pass code (step 413).

The record identification/verification technique employed by the present invention provides numerous advantages over those techniques employed by the known prior art. For example, the technique of the present invention is advantageous as compared to those systems which require the patient to carry on his/her person some type of identification device (such as a “smart card”, a pendant, a bracelet, etc.) in that such devices may be easily lost, forgotten at home and/or may not be readily located on the person of a patient, particularly in an emergency situation.

The technique of the present invention is advantageous over systems which require the patient to supply passwords, personal identification numbers (PINs), or the like to grant viewing access to his/her medical records in that such information may be easily forgotten by the patient such that even the patient himself/herself may not be able to provide a healthcare practitioner with access to his/her medical records if he/she forgets the identification information. Similarly, the technique of the present invention is also useful in emergency situations, where the patient may be unconscious and therefore unable to supply identification verification information. Moreover, by using patient biometric information, medical records can be retrieved and authority to view them verified without even needing to know a patient's name, and as such, the technique of the present invention may be used to easily maintain medical records completely anonymously. Thus, even if the medical records database becomes compromised, patient confidentiality can still be maintained. Furthermore, the present invention allows patients and/or their health care providers to securely update or add data to their medical record maintained in a centralized repository.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for viewing and updating medical records using patient biometrics, comprising:
at least one biometrics database including a plurality of biometric identifiers;
at least one records database including a plurality of medical data records;
at least one biometrics reader for receiving two or more biometric identifiers from a patient;
a central records processor;
software executing on said processor for querying the at least one biometrics database to verify the two or more biometric identifiers; and
software executing on said processor for retrieving a medical data record corresponding to the two or more biometric identifiers from the at least one records database.

2. The system according to claim 1, further comprising:
a pass code reader for receiving a unique pass code corresponding to the medical data record; and
software executing on said processor for receiving medical data and storing the medical data in the records database upon verification of the unique pass code.

3. The system according to claim 2, wherein the pass code reader is selected from a group consisting of a keyboard, a secure keypad, and a voice recognition device.

4. The system according to claim 1, further comprising:
a pass code reader for receiving a pass code; and
software executing on said processor for receiving medical data and storing the medical data in the records database upon verification of the pass code and the two or more biometric identifiers.

5. The system according to claim 4, wherein the medical data is stored in a location of the records database corresponding to the pass code and the two or more biometric identifiers.

6. The system according to claim 1, wherein the two or more biometric identifiers include at least two of fingerprint data, iris data, and DNA data.

7. The system according to claim 1, wherein the two or more biometric identifiers include skeletal topography data.

8. The system according to claim 1, wherein the two or more biometric identifiers include one of digital data and physical specimens.

9. The system according to claim 1, wherein said central processor is in communication with said at least one biometrics reader via the Internet.

10. The system according to claim 1, wherein the at least one biometrics reader is located at a healthcare facility, wherein the system further comprises software executing on said processor for providing the medical data record to the healthcare facility.

11. The system according to claim 1, wherein the medical record includes an electronic birth certificate.

12. The system according to claim 1, further comprising:
software executing on said processor for determining a subscription status upon receipt of the two or more biometric identifiers;
software executing on said processor for generating a payment request; and
software executing on said processor for receiving an electronic payment.

13. A system for viewing and updating medical records using patient biometrics, comprising:
at least one biometrics database including a plurality of biometrics identifiers;
at least one records database including a plurality of medical data records;
at least one biometrics reader for receiving at least one biometric identifier from a patient;
a central records processor;
software executing on said processor for querying the at least one biometrics database to verify the at least one biometric identifier;
software executing on said processor for retrieving a medical data record corresponding to the at least one biometric identifier from the at least one records database;
software executing on said processor for receiving a pass code; and
software executing on said processor for receiving update data and storing the update data in the records database upon verification of the pass code.

14. The system according to claim 13, wherein said software for receiving the update data and storing the update data further verifies the at least one biometric identifier.

15. The system according to claim 14, wherein the medical data in stored in a location of the records database corresponding to the pass code and the at least one biometric identifier.

16. A method of generating an electronic medical record accessible using patient biometrics, comprising the steps of:
receiving a new record request from a user;
receiving a plurality of biometric identifiers from the user;
storing the plurality of biometric identifiers in a biometrics database;
associating a pass code with the plurality of biometric identifiers;
receiving medical data; and
storing the medical data in a location of a record database corresponding to at least one of the pass code and the plurality of biometric identifiers.

17. The method according to claim 16, wherein the medical record data includes electronic birth certificate data.

18. The method according to claim 18, wherein the step of receiving biometric identifiers includes receiving one or more physical specimens from the user and generating the plurality of biometric identifiers therefrom.

19. A method of accessing an electronic medical record using patient biometrics, comprising the steps of:
receiving at least one biometric identifier pertaining to a patient from a healthcare computer;
querying a biometrics database to determine a medical data record associated with the at least one biometric identifier;
querying a medical records database to retrieve the medical data record; and
sending the medical data record to the healthcare computer for viewing.

20. The method according to claim 19, further comprising the steps of:
receiving a pass code;
verifying the pass code;
receiving medical data; and
updating the medical data record with the medical data.

21. The method according to claim 20, wherein the pass code is a unique alphanumeric pass code.

22. The method according to claim 20, wherein the step of verifying the pass code further includes verifying the at least one biometric identifier.
